(19) United States
(12) Patent Application Publication
(10) Pub. No.: US 2008/0038028 A1
(43) Pub. Date: Feb. 14, 2008

(54) SHEET CONVEYING APPARATUS, IMAGE FORMING APPARATUS AND IMAGE READING APPARATUS

(75) Inventor: Satoru TAKEZAWA, Nagareyama-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/781,435

(22) Filed: Jul. 23, 2007

(30) Foreign Application Priority Data
Aug. 8, 2006 (JP) 2006-216095

(51) Int. Cl. G03G 13/00

(52) U.S. Cl. 399/367

(57) ABSTRACT

A switch unit applies a voltage to each of a plurality of unit electrodes arranged in a matrix in a base material of a high resistance of an electrode array. A control unit controls the switch unit, changes a pattern of the voltage to be applied to the plurality of unit electrodes arranged in the matrix, and thereby generates an electrostatic force in a sheet conveying direction and a direction orthogonal to the sheet conveying direction, between a sheet and the electrode array.

### BACKGROUND OF THE INVENTION

1. Field of the Invention

The present invention relates to a sheet conveying apparatus, an image forming apparatus and an image reading apparatus, and more particularly, relates to a construction for correcting a skew feed or a shift in a width direction of a sheet such as a recording sheet or a document to be conveyed to an image forming portion or an image reading portion.

2. Description of the Related Art

Conventionally, in an image forming apparatus or an image reading apparatus such as a copying machine, a printer, a facsimile or a complex machine having plural functions, there is provided a sheet conveying apparatus conveying a sheet such as a recording sheet or a document to an image forming portion or an image reading portion.

Furthermore, as such a sheet conveying apparatus, there is the one in which a sheet is conveyed by the rotation in a state in which the sheet is pinched between a pair of rollers having a driving roller and a driven roller. When, however, the sheet is pinched and conveyed by the pair of rollers like this, in the case of a sheet of a small stiffness such as a thin paper, damages such as the occurrence of wrinkles or tear of the sheet are caused, which will be the cause of a jam. Moreover, there are some cases where due to the decrease of a frictional resistance between the rollers and the sheet owing to the abrasion of the rollers or a paper dust, the rollers are idled, and thus a sheet conveying accuracy is reduced.

Furthermore, there is a sheet conveying apparatus that includes a correction unit for correcting the posture and the position of a sheet until it is conveyed to the image forming portion or the image reading portion. As such a correction unit, there is the one in which the sheet is conveyed in an oblique direction intersecting a sheet conveying direction (hereinafter referred to as an oblique-feed), a side edge of the sheet is abutted against an abutment plate, being a reference of the conveyance of the sheet to correct a skew feed of the sheet and to correct a shift in the width direction of the sheet (hereinafter referred to as a lateral registration correction).

However, when the sheet is oblique-fed to be abutted against the abutment plate to make skew feed correction, or when a conveying roller is moved in the direction (hereinafter referred to as the width direction) orthogonal to the sheet conveying direction to make lateral registration correction, the sheet may be folded or bent. In particular, such a phenomenon is likely to occur in the case of a sheet of a small stiffness.

Then, as a construction for solving such problems, there is the one in which a sheet is conveyed electrostatically and with different speeds at both side edge portions in the width direction of the sheet. Thus conveying the sheet electrostatically with different speeds at both side edge portions enables conveyance without causing damages, even if e.g., the skew feed correction is made for a sheet of a small stiffness such as a thin paper. A sheet conveying apparatus of such a construction is disclosed in Japanese Patent Application Laid-Open No. H08-012118.

However, in such a conventional sheet conveying apparatus in which a sheet is conveyed electrostatically, although skew feed can be corrected by conveying the sheet with different speeds at both side edge portions at left and right of the sheet, the lateral registration correction, being the correction of a shift in the width direction of the sheet cannot be made. That is, although the sheet can be conveyed without suffering damage, the registration in the width direction of the sheet cannot be made with a high accuracy.

### SUMMARY OF THE INVENTION

Accordingly, the present invention has been made in view of such present circumstances, and has an object of providing a sheet conveying apparatus with which a sheet can be conveyed without suffering damage, and the accuracy of registration of the sheet can be improved.

The present invention is a sheet conveying apparatus conveying a sheet by an electrostatic force comprising: an electrode array in which a plurality of microelectrodes is arranged in a matrix in a base material of a high resistance; a voltage applying unit applying a voltage to each of the microelectrodes arranged in the matrix; and a voltage control unit controlling the voltage applying unit, and changing a pattern of a voltage to be applied to the microelectrodes arranged in the matrix, wherein the voltage control unit changes the pattern of the voltage to be applied to the microelectrodes such that between the sheet to be conveyed and the electrode array, an electrostatic force in a sheet conveying direction and a direction orthogonal to the sheet conveying direction is generated.

Further features of the present invention will become apparent from the following description of exemplary embodiments with reference to the attached drawings.

### BRIEF DESCRIPTION OF THE DRAWINGS

FIG. 1 is a diagram illustrating a construction of an image forming apparatus including a sheet conveying apparatus according to an exemplary embodiment of the present invention.

FIG. 2 is a diagram illustrating an electrode arrangement of an electrode array provided in an automatic document feeder as one example of the above-mentioned sheet conveying apparatus.

FIG. 3 is a control block diagram of the above-mentioned automatic document feeder.

FIGS. 4A, 4B, 4C and 4D are diagrams illustrating a cross section and a voltage applying pattern of the above-mentioned electrode array.

FIG. 5 is a flowchart showing a conveyance control of the document in the above-mentioned electrode array.

FIG. 6 is a diagram illustrating a voltage applying pattern when the document of the above-mentioned electrode array is oblique-fed.

FIGS. 7A and 7B are diagrams illustrating a voltage applying pattern of the above-mentioned electrode array when a skew feed of the document is corrected.

FIG. 8 is a diagram illustrating a voltage applying pattern of the above-mentioned electrode array when an oblique-feed correction and a skew feed correction of the document are made.

### DESCRIPTION OF THE EMBODIMENT

Hereinafter, a best mode for carrying out the present invention will be described in detail referring to the drawings.

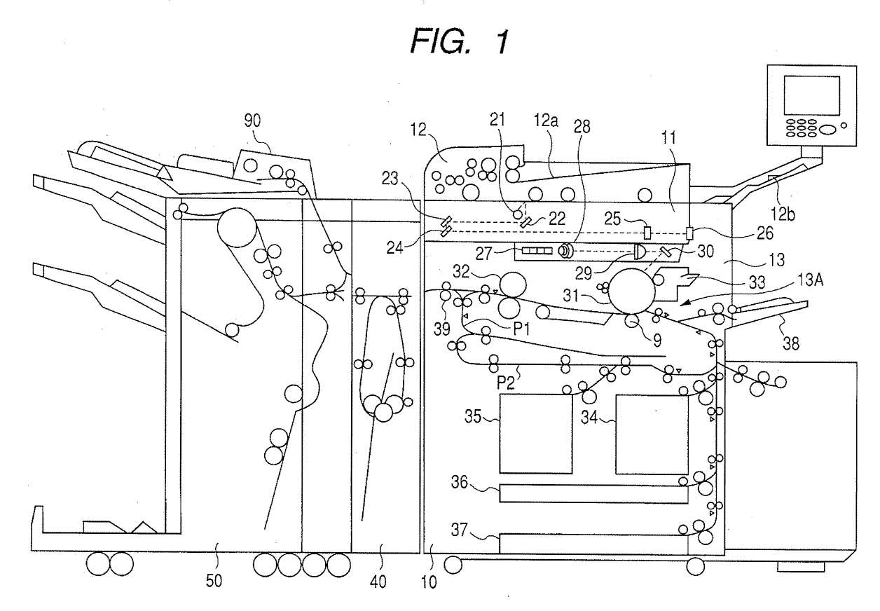

FIG. 1 is a diagram illustrating a construction of an image forming apparatus provided with a sheet conveying apparatus according to an embodiment of the present invention. This image forming apparatus includes an image forming apparatus main body 10, a folding apparatus 40 and a finisher 50.

The image forming apparatus main body 10 has an image reader 11, being an image reading apparatus reading an image of the document, and a printer portion 13 forming an image on a recording sheet (sheet).

The image reader 11 has a scanner unit 21, and an automatic document feeder 12 for automatically conveying a document onto a platen glass, being a reading position by the scanner unit 21. Further, in the case of reading an image of the document, the automatic document feeder 12 feeds documents that are set in a face-up state on a document tray 12a (not shown) in sequence from a leading page, and conveys it onto the platen glass via a curved path to stop it in a predetermined position.

Then, the scanner unit 21 is made to scan in the afore-mentioned state from the left side to the right side while irradiating a face to be read of the document with a light from a lamp. Here, when the scanner unit 21 scans while irradiating the light like this, the light reflected from the document is led to an image sensor 26 via mirrors 22 to 24 and a lens 25, and thereafter the image of the document is focused onto an imaging surface of the image sensor 26. Whereby, the image of the document is read in each line in a main scanning direction.

In this way, while the image of the document is being read by the image sensor 26 in each line in the main scanning direction, the scanner unit 21 is conveyed in a sub-scanning direction, thereby reading the entire image of the document. Incidentally, when reading of the image is ended, the automatic document feeder 12 discharges the document toward a sheet discharge tray 12b.

The image having been optically read in this way is first converted into an image data by the image sensor 26, and is output. This image data is subjected to a predetermined processing at an image processing portion (not shown) and thereafter input as a video signal to the printer portion 13.

At the printer portion 13, based on the video signal having been input, a laser light to be output from a laser element (not shown) is modulated. Then, this laser light having been modulated, while being scanned by a polygon mirror 27, is applied onto a photosensitive drum 31 provided in an image forming portion 13A via lenses 28 and 29 and a mirror 30. Whereby, on the photosensitive drum 31, an electrostatic latent image in accordance with the laser light having been scanned is formed. Thereafter, this electrostatic latent image on the photosensitive drum 31 is made to be a visible image as a developer image with a developer to be fed from a developing device 33.

Furthermore, in a timing synchronized with the start of the application of a laser light, a sheet is fed from each cassette 34 to 37, a manual sheet feeding portion 38 or a duplex conveying path, and this sheet is conveyed to a transfer portion that includes the photosensitive drum 31 and a transfer roller 9. Then, the developer image that is formed on the photosensitive drum 31 is transferred onto the sheet having been fed at the transfer portion.

Subsequently, the sheet onto which the developer image has been transferred is conveyed to a fixing portion 32, and heated and pressurized at the fixing portion 32, whereby the developer image is fixed. Then, the sheet having passed this fixing portion 32 is discharged from the printer portion 13 to the outside (folding apparatus 40) through a flapper (not shown) and a discharge roller 39.

Here, when the sheet is discharged with the image formed side thereof facing downward (in a face-down state), the sheet having passed the fixing portion 32 is once guided into a reversing path P1 by a switching operation of the flapper (not shown). Then, after a trailing edge of the sheet has passed the flapper, the sheet is switched back to be discharged from the printer portion 13 by the discharge roller 39.

Furthermore, when a duplex recording of an image formation on both sides of the sheet is set, the sheet is guided to the reversing path P1 by the switching operation of the flapper. Subsequently, thereafter, this sheet is conveyed to the duplex conveying path P2, and the sheet having been guided to the duplex conveying path P2 is fed again to between the photosensitive drum 31 and the transfer portion in the above-described timing.

Incidentally, when a sheet of a large stiffness such as an OHP (overhead projector) sheet is fed from the manual sheet feeding portion 38, and an image is formed on this sheet, the sheet is not guided into the reversing path P1, but discharged by the discharge roller 39 with the image formed side thereof facing upward (in a face-up state).

Whereas, at the folding apparatus 40 to which the sheet having been discharged from the printer portion 13 is fed, a sheet is processed to be folded in Z shape. For example, when the sheet is of A3 size or B4 size, and when a folding process is designated, folding is conducted at the folding apparatus 40. Incidentally, in the other cases, the sheet having been discharged from the printer portion 13 passes through the folding apparatus 40 to be fed to the finisher 50.

The finisher 50 acts to make each processing such as bookbinding, stapling, and punching. This finisher 50 is provided with an inserter 90 feeding special sheets such as a book cover or a slip sheet to be inserted into the sheets on which images are formed. Then, the sheet having been subjected to a designated processing at this finisher 50 is discharged to a sheet discharge tray.

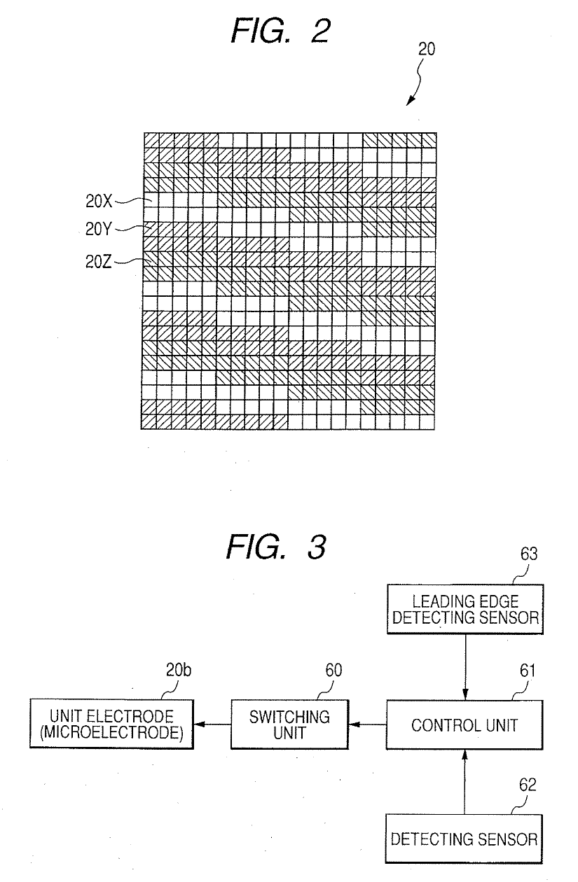

In this embodiment, the automatic document feeder 12 conveying a document includes a skew feed correcting portion, which corrects a skew feed and a lateral registration of the document and conveys the document to the image reading portion. In this skew feed correcting portion, by making the correction of a skew feed and a lateral registration of the document, the accuracy of reading an image of the document can be improved. Here, this skew feed correcting portion, as illustrated in FIG. 2, includes an electrode array 20 in which unit electrodes 20b, each being formed of plural, in this embodiment, three microelectrodes (not shown) are arranged in a matrix.

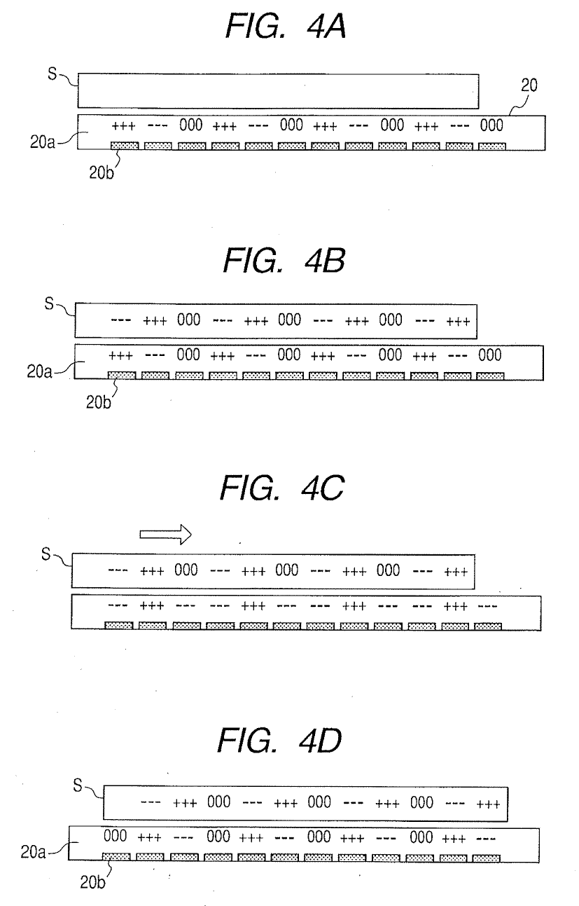

FIGS. 4A, 4B, 4C and 4D are cross-sectional diagrams of such an electrode array 20. The electrode array 20 is constructed such that the unit electrodes 20b are embedded in a matrix at a constant pitch in a base material 20a made of a film-like resistor having a high resistance. That is, plural numbers of not less than three unit electrodes 20b are arranged in a sheet conveying direction and in a direction orthogonal to the sheet conveying direction.

Incidentally, as shown in FIG. 3, a switch unit 60, being a voltage applying unit switching and applying a voltage is connected to each microelectrode of this unit electrode 20b. Furthermore, to this switch unit 60, connected is a control unit 61, being a voltage control unit controlling the switch unit 60, and changing the pattern of a voltage to be applied to (each microelectrode of) the unit electrode 20b.

With this control unit 61, the switch unit 60 is controlled, and a voltage is input to each unit electrode 20b in a predetermined pattern, thereby causing the pattern of a voltage of the electrode array 20 to change. Then, by changing a voltage applying pattern of the electrode array 20 in this way, a document is conveyed (electrostatic-conveyed) by a static electricity, as well as the skew feed and the lateral registration of the document can be corrected.

First, an operation principle of an electrostatic conveyance of a document using such an electrode array 20 is described.

FIGS. 4A, 4B, 4C and 4D illustrate states in which a document S having been fed from the document tray 12a is located on the electrode array. Furthermore, when the document S is conveyed, a voltage applying pattern as illustrated in FIG. 4A is applied to each unit electrode 20b. In specific, voltages of a predetermined magnitude of poles of + (plus) and − (minus), and 0 V are alternately applied, in succession from the left, to each of the unit electrodes 20b that are embedded at a constant pitch, to form a voltage applying pattern. Accompanied thereby, the side of the document S opposed to the unit electrodes 20b, as illustrated in FIG. 4B, is charged in order of − (minus), + (plus), and 0 V, which are contrary to those of the unit electrodes 20b.

Subsequently, the switch unit 60 is controlled by the control unit 61, and as illustrated in FIG. 4C, a voltage applying pattern to be applied to the unit electrode 20b is changed over. That is, the voltage of − (minus) is applied to the unit electrode 20b applied with the voltage of + (plus), the voltage of + (plus) is applied to the unit electrode 20b applied with the voltage of − (minus), and the voltage of − (minus) is applied to the unit electrode 20b applied with 0 V.

Here, when such voltages are applied, although an electric charge of the unit electrode 20b is instantaneously changed over, the electric charge in the document remains in a document position for a while because the electric charge in the document is prevented by the high resistance of the base material 20a. As a result, as illustrated in FIG. 4C, at the portion of + (plus) of the unit electrode 20b and + (plus) of the document S, and at the portion of − (minus) of the unit electrode 20b and − (minus) of the document S, between the unit electrode 20b and the document S, a repulsive force due to a static electricity is exerted. Incidentally, no repulsive force owing to a static electricity is exerted in a voltage portion of − (minus) and the portion of 0 V.

Furthermore, at this time, with respect to the unit electrode 20b of − (minus) and the unit electrode 20b of + (plus), a voltage portion of + (plus) and a voltage portion of − (minus) of the document S are positioned at the upper right, so that an attractive force due to a static electricity is exerted between the unit electrode 20b and the document S. Whereby, the entire document is exerted with a rightward force and moved to be in a state illustrated in FIG. 4D.

Here, this state of FIG. 4D is the same as the first state of FIG. 4B. Incidentally, when a time period has elapsed in this state, the amount of an electric charge on the document is decreased, so that in the state of FIG. 4D, the same voltages as those of FIG. 4A are applied to each unit electrode 20b again, to charge the document S. Then, by repeating such a series of operations of FIGS. 4A, 4B, 4C and 4D, the document S is sequentially moved, at each time being by one unit electrode. As a result, the conveyance of the document S can be made. Note that by continuously causing the unit electrodes 20b to be − (minus) or + (plus), a movement amount accompanied by one change of a voltage applying pattern of the document S can be increased.

Now, a conveyance control of the document S is described.

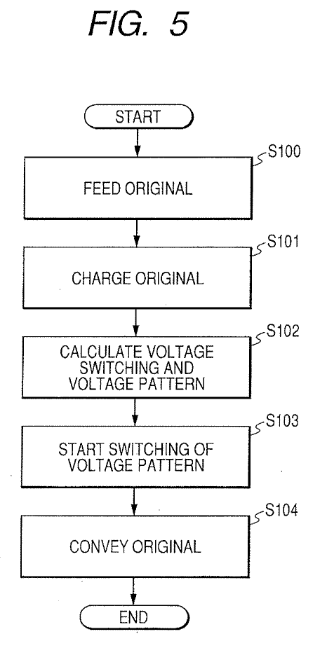

To make a lateral registration correction of the document S, the case where the document is conveyed in an oblique direction crossing the conveying direction (hereinafter referred to as an oblique-feed) is described with reference to a flowchart shown in FIG. 5.

At the automatic document feeder 12, first, a document is fed onto the electrode array where the unit electrodes are arranged in a matrix (S100). Incidentally, at this time, the document has only to be linearly conveyed onto the electrode array 20, so that as a unit of conveying the document onto the electrode array 20, any conveying unit such as rubber rollers or a suction may be used.

Subsequently, a voltage is applied to the microelectrodes forming the unit electrodes in order to provide an initial electric charge to the document (refer to FIG. 4A), and thus the document on the electrode array is charged (S101).

Then, the control unit 61, from the interval between the unit electrodes and desired document conveying speed and lateral registration position (an adequate position in the direction orthogonal to the conveying direction of the document), calculates an applying (switching) timing of a voltage that has to be applied to the unit electrodes for conveying the document at desired conveying speed and oblique-feed angle. In addition, required voltage and voltage applying pattern are calculated (S102).

Here, a voltage applying pattern is the pattern oblique at a predetermined angle with respect to the conveying direction, for example, as is illustrated in the already-descried FIG. 2. Incidentally, in FIG. 2, the portion of 20X shows the portion to be applied with a plus voltage of the electrode array 20, the portion of 20Y shows the portion to be applied with a minus voltage of the electrode array 20, and the portion of 20Z shows the portion of no voltage (0 V) of the electrode array 20. Here, in the sheet conveying direction, the voltage applying pattern is changed every two electrodes; and in the direction orthogonal to the sheet conveying direction, the voltage applying pattern is changed every five electrodes. In this way, by changing the voltage applying pattern every plural electrodes in the sheet conveying direction and in the direction orthogonal to the sheet conveying direction, the voltage applying pattern for making an oblique-feed of the document is formed.

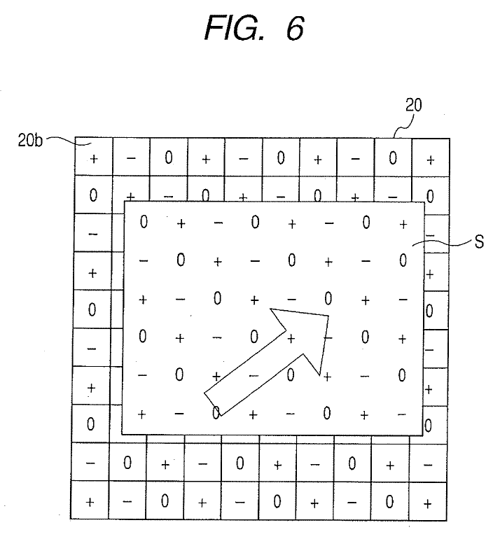

The control unit 61 calculates an oblique angle of this voltage applying pattern on the basis of a lateral registration position based on a signal from a detecting sensor 62 detecting a lateral registration of the document illustrated in FIG. 3, and a document conveying speed to obtain the voltage applying pattern. Incidentally, as a result of this calculation, in the case of obtaining a pattern as illustrated, for example, in FIG. 6, electric charges as illustrated in FIG. 6 are generated in positions opposed to each of the unit electrodes 20b of the document S.

Subsequently, in a timing and in a voltage applying pattern obtained in a calculation step in S102, started is switching of the voltage applying pattern to be applied to the unit electrodes 20b (S103). Then, when switching of the voltage applying pattern is started, by a series of operations as illustrated in the already-described FIGS. 4A, 4B, 4C and 4D, the oblique-feed of the document is started.

Incidentally, when the document is oblique-fed in this way, and a signal indicating that the lateral registration correction of the document has completed is input from the detecting sensor 62, the control unit 61, in synchronization with this timing, changes the voltage applying pattern to the pattern of causing the document to go straight in the sheet conveying direction.

Like this, in the case of making the lateral registration correction of an document, first a voltage applying pattern of making an oblique-feed of the document from an end position of the sheet in the width direction is calculated, and when the lateral registration correction is ended, the voltage applying pattern is changed to the pattern of causing the document to go straight. Furthermore, by such switching of the voltage applying pattern, the document can be conveyed in a state in which the position in the width direction is corrected. Note that the accuracy of the lateral registration correction at this time is of a dot size of the unit electrode, so that registration can be made with accuracy.

Now, the case of correcting the skew feed (skew) of a document is described.

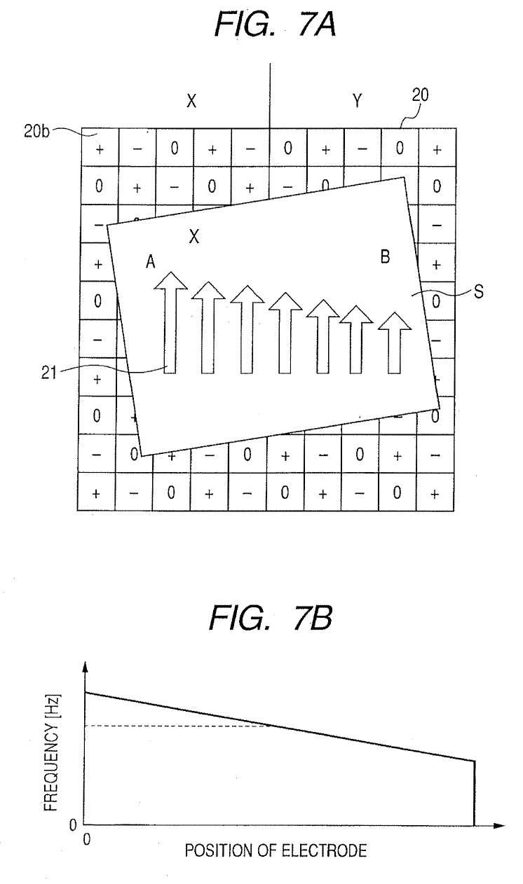

In the case of making a skew feed correction of the document, as a voltage applying pattern with respect to the electrode array 20, the pattern as illustrated in FIG. 7A is employed, as well as the document S oblique as illustrated in FIG. 7A is turned so as to return to be parallel.

Here, in the case of turning the document S, speeds in the conveying direction of the document passing on the unit electrodes need to be different. For example, the document S needs to be conveyed at a higher speed on A side illustrated in FIG. 7A, and needs to be conveyed at a lower speed on B side.

Therefore, in this embodiment, a switching rate of the voltage applying pattern with respect to the unit electrodes on A side is made to be higher, and a switching rate with respect to the unit electrodes on B side is made to be lower. Whereby, there will be a difference between conveying speeds on A side and on B side of the document as indicated by arrows 21, and the document S will be turned due to this conveying speed difference.

Furthermore, at the electrode array 20, by changing the switching rate of the voltage applying pattern in proportion to respective distances to A side and B side from the center as a reference of the conveyance of the document S, a turning force can be uniformly provided with respect to the document S. Incidentally, to provide a turning force uniformly with respect to the document S in this way, in switching of the voltage applying pattern, there is provided a difference in frequency as illustrated in FIG. 7B.

That is, as illustrated in FIG. 7B, at a central portion of the document S, the frequency is a switching frequency for a predetermined conveying speed (broken line), and with respect to the unit electrodes on A side from the document center where a conveying speed is high, the switching frequency is made higher in proportion to the distance from the document center. In addition, with respect to the unit electrodes on B side from the document center where a conveying speed is low, the switching frequency is made lower in proportion to the distance from the center.

Incidentally, in the case of turning the document S, the control unit 61 reads a skew feed angle of the document by leading edge detecting sensors illustrated in FIG. 3 that are provided spaced apart by a predetermined distance in the width direction, calculates a turning speed of the document in accordance with this skew feed angle, and reflects it on the switching timing of the voltage applying pattern.

In this way, in the case of correcting the skew feed of the document, first a voltage applying pattern of turning the document is calculated in accordance with a skew feed angle of the document, and a skew feed correction is made based on this calculation. When the skew feed correction is ended, the voltage applying pattern is changed to the pattern of causing the document to go straight. Then, by such switching of the voltage applying pattern, the document can be conveyed in a state in which the skew feed is corrected.

Note that employing an oblique-feed method and a turning method of a document as described heretofore, the lateral registration correction and the skew feed correction can be made at the same time.

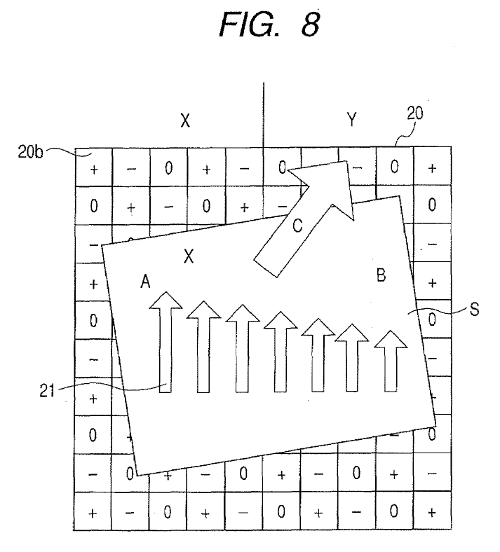

In this case, as illustrated in FIG. 8, by causing a voltage applying pattern to be applied to the unit electrodes 20b to be such a pattern as at the time of oblique-feed, a force indicated by an arrow C is exerted on the document S. Furthermore, the switching frequency of the voltage applying pattern is changed in accordance with the skew feed angle of the document S.

That is, switching of the voltage applying pattern with respect to the unit electrodes on A side is made at a higher frequency than that at the center in proportion to the distance from the document center, and switching of the voltage applying pattern with respect to the unit electrodes on B side is made at lower frequency than that of the center in proportion to the distance therefrom. Whereby, there will be a speed difference between A side and B side of a sheet, a turning force is generated at the document S due to a speed difference between these A side and B side, and the skew feed correction can be conducted.

In this way, by changing the voltage applying pattern to be applied to the unit electrodes, when conveying a document by an electrostatic conveyance, there is no force forcibly exerted on the document. Whereby, even with the document of a small stiffness, the skew feed correction and the lateral registration correction can be made without the document being bent.

As described above, due to that the pattern of a voltage to be applied to the unit electrodes such that between the document S and the electrode array 20, an electrostatic force in the conveying direction and the direction orthogonal to the conveying direction is generated, a sheet can be conveyed without suffering damages.

In addition, by the control unit 61, a voltage applying pattern with respect to the unit electrodes is switched, and the document is conveyed at a pitch of the unit electrodes. Therefore, the registration of the document can be conducted at a unit of the pitch of the electrodes, and thus a registration accuracy of the sheet can be improved.

Moreover, by the control unit 61, the switching operation of a voltage applying pattern is made independently in respective unit electrodes. Therefore, even in the case of the occurrence of a skew feed of the document, by changing the switching frequency of the voltage applying pattern to be applied to respective unit electrodes, the skew feed of the document can be corrected.

In addition, due to that a voltage applying pattern is changed, as well as the switching frequency of the voltage applying pattern is changed in accordance with the position of the electrodes in the matrix, the skew feed correction and the lateral registration correction can be made at the same time. In addition, because rollers and motor that drives the rollers are unnecessary, it becomes an easy composition. Therefore, it leads to the miniaturization of the sheet conveying route, and the entire image forming apparatus can be miniaturized.

Incidentally, in the heretofore descriptions, described is the case where a sheet conveying unit according to the present invention is used in the image reader 11, being an image reading apparatus. The present invention, however, is not limited to this case, but can be for use in the conveyance of a recording sheet S at the printer portion 13 illustrated in FIG. 1. That is, by the application of the present invention to a registration portion located on the upstream side of the image forming portion 13A, a recording sheet can be conveyed without skew to the image forming portion 13A, and thus an accurate registration of the recording sheet and an image to be transferred can be made. Whereby, an image formation of a high quality can be conducted.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-216095, filed Aug. 8, 2006, which is hereby incorporated by reference herein in its entirety.

What is claimed is:

1. A sheet conveying apparatus conveying a sheet by an electrostatic force comprising:
a plurality of electrodes arranged in a matrix; and
a voltage applying unit applying a voltage to each of the electrodes,
wherein a voltage applying pattern to be applied to each of the electrodes by the voltage applying unit can be changed so as to convey the sheet in a sheet conveying direction and in a direction intersecting with the sheet conveying direction.

2. A sheet conveying apparatus according to claim 1, wherein the voltage applying pattern is formed by applying alternately voltages of + (plus) and − (minus) poles and 0 V to the electrodes.

3. A sheet conveying apparatus according to claim 2, wherein the voltages of + (plus) and − (minus) poles, and 0 V are applied alternately to every plural electrodes in the sheet conveying direction and the direction orthogonal to the sheet conveying direction.

4. A sheet conveying apparatus according to claim 1, wherein a switching frequency of the voltage applying pattern to be applied to each of the electrodes is controlled to change a speed of the sheet to be conveyed.

5. A sheet conveying apparatus according to claim 1, wherein a switching rate of the voltage applying pattern to be applied to each of the electrodes is controlled to cause a difference between sheet conveying speeds in the sheet conveying direction of the sheet to be conveyed.

6. An image forming apparatus comprising:
a sheet conveying apparatus conveying a sheet by an electrostatic force; and
an image forming portion forming an image on the sheet conveyed by the sheet conveying apparatus,
the sheet conveying apparatus including:
a plurality of electrodes arranged in a matrix; and
a voltage applying unit applying a voltage to each of the electrodes,
wherein a voltage applying pattern to be applied to each of the electrodes by the voltage applying unit can be changed so as to convey the sheet in a sheet conveying direction and in a direction intersecting with the sheet conveying direction.

7. An image reading apparatus comprising:
a sheet conveying apparatus conveying a sheet by an electrostatic force; and
an image reading portion reading an image of the sheet conveyed by the sheet conveying apparatus,
the sheet conveying apparatus including:
a plurality of electrodes arranged in a matrix; and
a voltage applying unit applying a voltage to each of the electrodes,
wherein a voltage applying pattern to be applied to each of the electrodes by the voltage applying unit can be changed so as to convey the sheet in a sheet conveying direction and in a direction intersecting with the sheet conveying direction.
